(19) United States
(12) Patent Application Publication
(10) Pub. No.: US 2017/0220592 A1
(43) Pub. Date: Aug. 3, 2017

(54) MODULAR DATA OPERATIONS SYSTEM

(71) Applicant: Microsoft Technology Licensing, LLC, Redmond, WA (US)

(72) Inventor: Forrest Curtis Foltz, Woodinville, WA (US)

(21) Appl. No.: 15/012,489

(22) Filed: Feb. 1, 2016

(51) Int. Cl. G06F 17/30; G06F 3/06; G06F 12/08

(52) U.S. Cl. CPC G06F 17/30132; G06F 12/0804; G06F 12/0813; G06F 12/0877; G06F 3/0613; G06F 3/0643; G06F 3/067

(57) ABSTRACT

In various embodiments, methods and systems, for implementing modular data operations, are provided. A data access request, associated with data, is received at a data access component. The data access component selectively implements modular data operations functionality based on configuration settings. A translation table associated with a working set is accessed, based on the configuration settings of the data access component, to determine a location for executing the data access request. The data access request is executed using the cache store or a backing store associated with the working set. The data access request is executed using the location that is determined using the translation table of the working set. The data access request is executed using the cache store when the data is cached in the cache store and the data access requested is executed based on the backing store when the data is un-cached in the cache store.

### BACKGROUND

Cloud computing infrastructures (distributed computing systems) support operations on a shared pool of configurable computing, storage, and networking resources. For example, a cloud computing infrastructure can implement a compute node configured to run multiple virtual machines (VMs) supported by on operating system (OS). Compute nodes provision resources assigned to VMs. Compute nodes are now supporting an increasing number of VMs as demand for compute capacity in cloud computing infrastructures continues to grow. However, an increase in the number of VMs of compute nodes impacts performance of the underlying data compute, storage and network resources which are implemented to meet the input/output (I/O) requirements of the increasing number of VMs on the compute nodes. As such, tools are needed to manage and control VM data operations in order to improve performance in cloud computing infrastructures.

### SUMMARY

Embodiments described herein provide methods and systems for managing and controlling data operations in distributed computing systems based on a modular data operations system. At a high level, the modular data operations system leverages a redirector file system, a backing store, and a cache store, using a data access component, to improve data access performance. The data access component also implements cache store data structures, cache block lazy writing and data access throttling as part of a modular data operations systems framework. The modular data operations system includes several components that can be selectively implemented as needed to improve performance in accessing data (e.g., read or write file system data) stored a distributed computing system. In particular, a data access component uses the redirector file system, operable based on a file proxy (e.g., a surface), to gain access to the backing store. The data access component further configures cache store data structures (e.g., a working set operating with translation tables of backing stores) for a cache store (e.g., compute node SSD or RAM) to operate with the backing store (e.g., blob store having a translation table) as data (e.g., page blobs) in the backing store is accessed using the file proxy. The cache store caches data associated with data access requests (e.g., a read operation or write operation). As such, the cache store includes at least a subset of data from the backing store. The cache store operates based on cache store data structures (e.g., a working set) configured using data access component. In particular, configuration settings can be defined in the data access component to support components of the modular data operations system. The cache store data structure includes a two-tiered cache system associated with a translation table (e.g., block address translation table for a corresponding backing store) for accessing data of a data access request. Using the cache store data structure, data can be accessed at the cache store or the backing store operating as repositories for data objects defined therein. Data can refer to a sequence of one or more symbols given meaning by specific acts of interpretation. The data can be memory addresses stored in different data structures supported at the cache store or backing store.

The data access component supports different types of caching policies, as such, cache blocks are processed based on a corresponding caching policy. In various embodiments of the present disclosure, the data access component can also implement a cache block lazy writer to lazily write cache blocks. The data access component also supports a data access throttling component to limit the maximum number or rate of input/output (I/O) requests processed at the data access component. In particular, the data access component implements throttling for processing data requests at the different components of the modular data operations system to provide consistent performance when accessing requested data.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary modular data operations system in which embodiments described herein may be employed;

FIG. 2 is a block diagram of an exemplary modular data operations system in which embodiments described herein may be employed;

FIG. 3 is a block diagram of an exemplary modular data operations system in which embodiments described herein may be employed;

FIG. 4 is a flow diagram showing an exemplary method for managing and controlling data access based on a modular data operations system, in accordance with embodiments described herein;

FIG. 5 is a flow diagram showing an exemplary method for managing and controlling data access based on a modular data operations system, in accordance with embodiments described herein;

FIG. 6 is a block diagram of an exemplary computing environment suitable for use in implementing embodiments described herein; and

FIG. 7 is a block diagram of an exemplary distributed computing system suitable for use in implementing embodiments described herein.

### DETAILED DESCRIPTION

Cloud computing infrastructures (i.e., distributed computing systems) support operations on a shared pool of configurable computing, storage, and networking resources. For example, a cloud computing infrastructure can implement a compute node configured to run multiple virtual machines (VMs) supported by on operating system (OS). Compute nodes provision resources assigned to VMs. The VMs support operation of one or more hosted applications (e.g., tenants) in the cloud computing infrastructure. The tenants may specifically employ any type of OS (e.g., Windows or Linux). The cloud computing infrastructure can also implement a fabric controller that operates to provision and manage resource allocation, deployment, upgrade and management of clouds resources, services and applications. In particular, the fabric controller may implement a hypervisor, a hypervisor generally refers to a piece of computer software, firmware or hardware that creates and runs virtual machines.

A compute node in a cloud computing infrastructure that is supported via the fabric controller hypervisor operates as a host machine for VMs. The hypervisor presents VMs running operating systems with a virtual operating platform and manages the execution of the VMs on the compute node and data communication therefrom. In this regard, multiple instances of a variety of operating systems may share the virtualized hardware resources. By way of example, the fabric controller can implement a virtualized storage stack for VMs to store data or virtualized computing stack for providing compute resources for various computing-based tasks. The virtualized storage stack or compute stack functionality is supported using a Virtual Hard Drive Miniport Driver (VHDMP) which exposes block devices (i.e., devices that support reading and writing whole blocks of data at a time e.g., sector on a hard disk). Block devices mounted using the VHDMP support access to a blob interface associated with a blob store within the cloud computing storage infrastructure such that the blob store is accessible to a VM as a Virtual Hard Drive (VHD). Systems and processes for managing virtual hard drives as blobs, as used in the present disclosure, are further described in U.S. application Ser. No. 13/944,627 filed Jul. 17, 2013 entitled “Managing Virtual Hard Drives as Blobs,” which is hereby incorporated herein by reference in its entirety.

Nodes of virtualized storage stacks or compute stacks, as technology continues to improve, are supporting an increasing number of VMs as demand for compute capacity in cloud computing infrastructures continues to grow. However, an increase in the number of VMs of compute nodes impacts performance of the underlying data compute, storage and network resources which are implemented to meet the input/output (I/O) requirements of the increasing number of VMs on the compute nodes. As such, tools are needed to manage and control VM access to requested data to improve performance in cloud computing infrastructures.

Embodiments of the present disclosure provide simple and efficient methods and systems for managing and controlling data operations in distributed computing systems based on a modular data operations system. At a high level, the modular data operations system leverages a redirector file system, a backing store, and a cache store, in combination with a data access component, to improve data access performance. The data access component implements cache store data structures, cache block lazy writing and data access throttling as part of a modular data operations systems framework. The modular data operations system includes several components that can be selectively implemented as needed to improve performance in accessing data (e.g., read or write file system data) stored a distributed computing system. In particular, a data access component uses the redirector file system, operable based on a file proxy (e.g., a surface), to gain access to the backing store. The data access component further configures cache store data structures (e.g., a working set operating with translation tables of backing stores) for a cache store (e.g., compute node SSD or RAM) to operate with the backing store (e.g., blob store) as data (e.g., page blobs) in the backing store is accessed using the file proxy. The cache store caches data associated with data access requests (e.g., a read operation or write operation). As such, the cache store includes at least a subset of data from the backing store. The cache store operates based on cache store data structures (e.g., a working set) configured using data access component. In particular, configuration settings can be defined in the data access component to support components of the modular data operations system. The cache store data structure includes a two-tiered cache system associated with a translation table (e.g., block address translation table) for accessing data of a data access request. Using the cache store data structure, data can be accessed at the cache store or the backing store operating as repositories for data objects defined therein. Data can refer to a sequence of one or more symbols given meaning by specific acts of interpretation. The data can be memory addresses stored in different data structures supported at the cache store or backing store.

The data access component supports different types of caching policies, as such, cache blocks are processed based on a corresponding caching policy. In various embodiments of the present disclosure, the data access component can also implement a cache block lazy writer component to lazily write cache blocks. The data access component also supports a data access throttling component to limit the maximum number or a rate of input/output (I/O) requests processed at the data access component. In particular, the data access component implements throttling for processing I/O requests at the different components of the modular data operations system to provide consistent performance when accessing requested data.

The modular data operations system functionality is operationally modular when implemented. Basically, the data access component utilizes the modular data operations system framework to selectively implement the different components of the modular data operations system. The selective implementation is based on initializing and configuring a data access component for a particular VM, compute node or cluster of compute nodes. By way of example, upon deploying and/or initializing a data access component as an agent on a compute node, an administrator of the compute node can select one or more modular data operations components and configure a modular data operations system configuration that defines features, attributes and selectable options for the redirector component, cache store component, the backing store component, the cache block lazy writer component and the data access throttle component amongst others. In this regard, the modular data operations system provides flexibility in implementing the different components to achieve various goals for computing tasks. Upon receiving a selection of attributes and options, the modular data operations system can be configured accordingly. By way of example, a first configuration may include the implementation of each of the components and another configuration may include the implementation of only a subset of the components.

The data access throttle component may address other issues with sharing compute node resources. By way of background, conventionally a customer deploying a new application on a node may prototype the application on the node and benchmark for scaling out the application. The benchmark is likely based on consistent performance because the VMs all support the same application in ideal conditions. In production, the VMs supporting the application may be provisioned with VMs supporting other applications that are hyper-active (e.g., noisy neighbor) and as such, the customer does not yield the same performance observed based on the prototype benchmarks. This issue is sometimes referred to as the noisy neighbor problem. The data access throttling component, as part of the modular data access system, can address this issue by providing for selectively and optional implementation of throttling. Throttling can refer to limiting the total number of data operations or rate of data operations based on a predefined threshold (e.g., predefined threshold condition). Throttling, in operation, may lead to idle resources but such a tradeoff allows for consistent and predictable performance for customers.

Throttling can be implemented in a variety of different configurations (e.g., above the cache or below the cache or shared throttling or isolated throttling). By way of example, “above the cache” throttling can refer to throttling data operations that are directed to the cache store and “below the cache” throttling can refer to throttling data operations that are directed to the backing store (e.g., Network Interface Controller (NIC) I/O requests on cache misses). “Shared throttling” can refer to a set of components or devices (e.g., four VMs) sharing the same predefined threshold condition for a selected throttle (e.g., 4 VMs are limited to 400 cache misses IOPS to a backing store) or “isolated throttling” where each device or component (e.g., VM) has an independent predefined threshold condition for a selected throttle (e.g., VM is limited to 400 cache misses IOPS to a backing store). Other variations and combinations of throttling are contemplated with embodiments of the present disclosure.

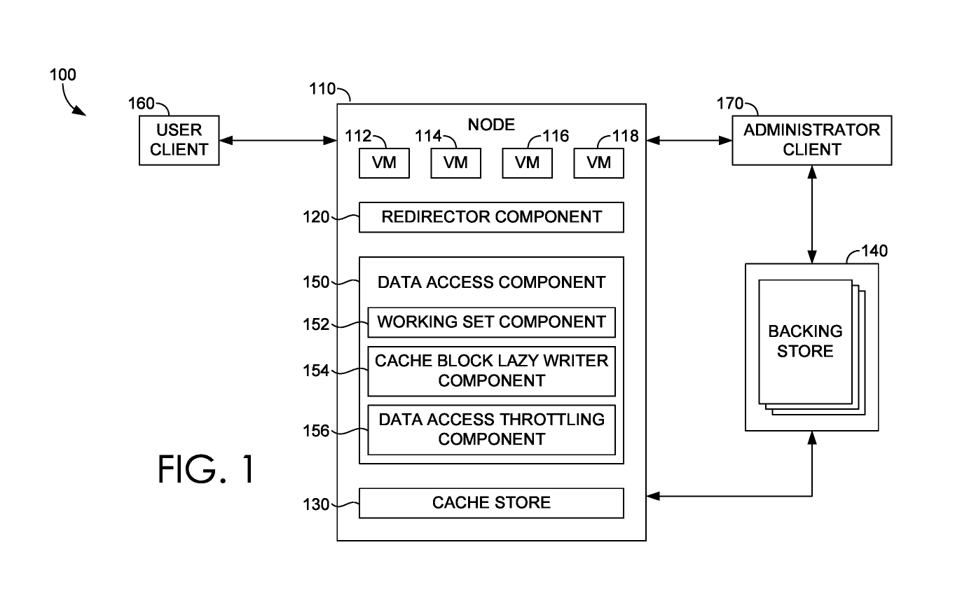

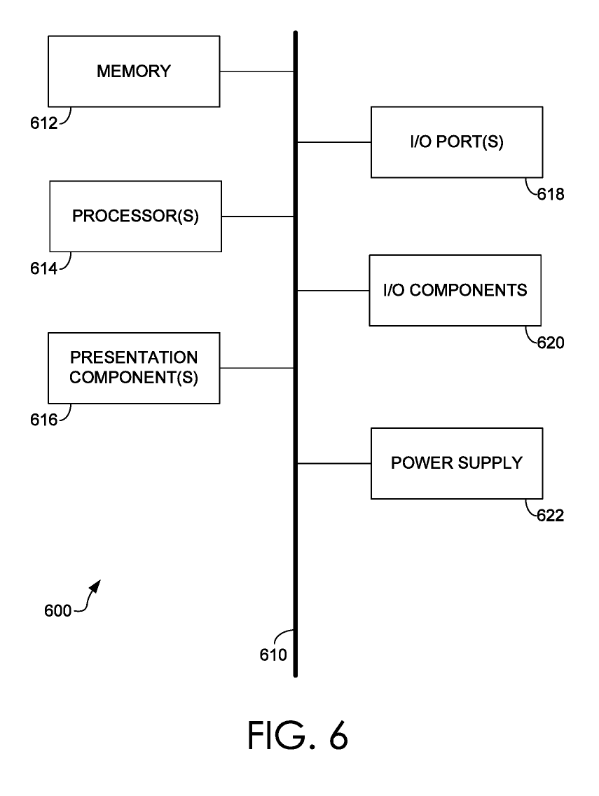

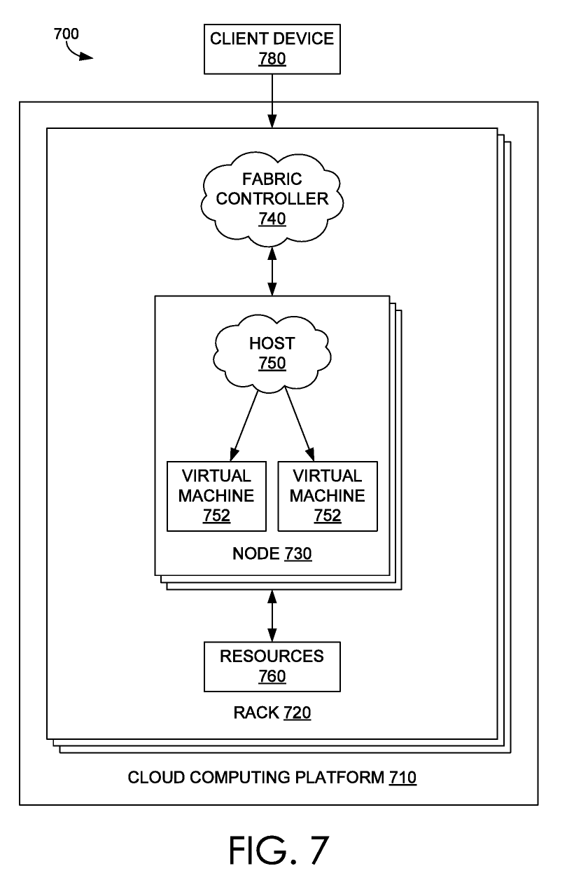

Referring initially to FIG. 1, FIG. 1 illustrates an exemplary modular data operations system 100 in which implementations of the present disclosure may be employed. In particular, FIG. 1 shows a high level architecture of a modular data operations system 100 with a node 110 having a redirector component 120, a cache store 130, a backing store 140 and a data access component 150 in accordance with implementations of the present disclosure. Among other components not shown, modular data operations system 100 includes the node 110 running VM 112, VM 114, VM 116 and VM 118, computing devices a user client 160 and an administrator client 170, the node, VMs, and computing devices are described in more detail with reference to FIGS. 6 and 7. The modular operations system 100 also includes the data access component 150 supporting a cache store working set via the working set component 152, a cache block lazy writer component 154, and a data access throttle component 156.

A system, as used herein refers, to any device, process, or service or combination thereof. A system may be implemented using components as hardware, software, firmware, a special-purpose device, or any combination thereof. A system may be integrated into a single device or it may be distributed over multiple devices. The various components of a system may be co-located or distributed. The system may be formed from other systems and components thereof. It should be understood that this and other arrangements described herein are set forth only as examples.

Having identified various components of the modular data operations system 100, it is noted that any number of components may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Further, although some components of FIG. 1 are depicted as single components, the depictions are exemplary in nature and in number and are not to be construed as limiting for all implementations of the present disclosure. The modular data operations system 100 functionality can be further described based on the functionality and features of the above-listed components.

Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Embodiments of the present disclosure are described in detail below with reference to examples such as, a file system supporting block-based cache store and a blob-based backing store. Additionally, exemplary attributes and specifications (e.g., surface file proxy, block sizes, tiers, cache types, page blobs etc.) are discussed. Nonetheless, the specific examples indicated are not meant to be limiting. In one exemplary embodiment, as shown in FIG. 1, the modular data operations system 100 includes a redirector component 120 (e.g., a driver, virtual driver, or system file) having a file-proxy (e.g., surface), a working set component 152 for supporting a two-tier working set stored in the cache store 130, a cache block lazy writer component 154, a data access throttling component 156 and a backing store 140. At a high level, the data access component receives data access requests via a file proxy and processes data requests based on the modular data operations system framework. In particular, the modular data operations system framework is based on using a data access component 150 to leverage the cache store 130 and a highly available backing store 140 in managing and controlling data operations.

With continued reference to FIG. 1, a redirector component 120 is responsible for providing access to a block device (VHD) that supports a redirector file system that operates with a backing store 140. A surface refers to a file proxy, in a file proxy format, which the redirector component 120 uses to redirect data access request to a cache store or the backing store. A requesting entity (e.g., user client 160 via a VM) directs the data access request to a VHD that is mounted as a block device but operates to provide access to the backing store 140 based on the redirector component 120 converting a data request from a file proxy format to a blob store format. Data access requests can refer to a read operation or write operation for data associated with a data access request. In operation, the redirector component 120 facilitates exposing a surface to the resources of the node 110 as a local file name in a root directory of a single system-wide drive letter. The surface supports accessing data stored in the cache store 130 or backing store 140. The drive letter for accessing the surface can be established when during an initialization phase of the data access component 150, for example, when deploying and/or configuring the data access component 150 as an agent hosted on a compute node. The initialization phase also includes the configuring cache store data structure elements (working set, translation tables, tiers, etc.) to operate with the cache store 130 and the backing store 140, as discussed herein in more detail.

The surface can be configured with to support a range of functionality for a redirector file system. A surface can support certain commands, for example, a surface can be enumerated, opened, closed, written and deleted. The commands can be based on a file system type supported by the surface. A surface may be connected to one backing store. The surface can be read-only or read-write based on the access configuration settings of a backing store of the corresponding surface. By way of example, a VM accesses surfaces that present as files in block device storage, such a VHD, however the surfaces redirect to a cache store or a backing store. The VM may request a file M:\foo.vhd, however, the foo.vhd is actually redirected to a page blob in the backing store the implemented a blob store. If a user executes “dir m:” in a command window, where m: is surface drive, any files listed are surfaces. The redirector component 120 may be configured to be agnostic to file formats. The surface can be configured as virtual hard disk (VHD) with virtual hard disk files (VHDX). The redirect component 120 also receives and processes hypervisor (e.g., a virtual machine monitor) requests for surfaces to support hypervisor functionality include creating and running virtual machines.

With continued reference to FIG. 1, FIG. 1 includes a backing store 140 (backing store component) responsible for supporting data operations in the backing store. The backing store 140 functions as a repository for data in the cloud computing infrastructure. As shown, the backing store 140 is not part of the node 110; however, it contemplated that the backing store 140 can be implemented as part of the node 110. The backing store 140 can include one or more redundant backing stores to support redundancy and high availability. In one embodiment, the data is in the form of blobs including page blobs in a blob store. A read data operation performed against an un-cached surface will result in a read from the blob store. Surfaces and backing stores together support the redirector file system. For example, a 4K read from offset zero of a surface will result in a 4K read offset zero of the backing page blob. The backing store 140 can support read-write and read-only data operations from surfaces referencing the backing store 140. The backing store 140 operates with a cache store 130 but the cache store 130 does not create or delete data in the backing store 140. The cache store 130 is configured (e.g., a registration process during an initialization phase) to perform data operations in a specific backing store 140. As such, the modular data operation system 100 can support a plurality of backing stores based on the corresponding configuration. During initialization, the backing store 140 specifications can facilitate the capacity of a cache store 130 to support file-system size semantics. The cache store 130 extends and contracts a size of a data (e.g., size of a page blob) to implement standard file-system semantics. For example, the page blobs can be multiples of 512 in size, so an actual file size may be recorded within the page blob in the form of metadata. By way of example, surface can operate like files (e.g., New Technology File System (NTFS) files), where file sizes can be set to byte-granularity, despite any sector-sized limitations of the underlying storage media. The file size that is exposed to client, i.e., the byte-granular size is stored as metadata within the page blob. In this regard, a client communicating a data access request for a surface can set a file size for a surface to byte granularity.

The backing store 140 can be assigned a caching policy from an administrator client 170 via the data access component 150. A caching policy may refer to a defined set of rules that are used to determine whether a data access request can be satisfied using a cached copy of the data. The backing store 140 can be configured with one of several different caching policies. A single caching policy may be associated with one backing store. When first establishing any backing store, the caching policy of “none” can be configured for the backing store, but it can be changed to another type in a subsequent configuration (e.g., during an initialization phase). As discussed, the data access component 150 selectively implements components of modular data operations system. For example, the node 110 can be configured with a redirector file system but configured without throttling or caching, as such, a page blob is not registered with the cache store 130 to expose surfaces that reference the page blob in the backing store 140. The data access component 150 can opt to implement caching for the backing store 140, as such, a cache type (other than “non-cached”) can be selected during an initialization phase to associate the backing store 140 with a cache store 130 and cache store data structures in the data access component 150.

The modular data operations system 100 supports several different cache types. A cache type of “none” can be associated with the backing store 140 to cause no caching of any reads or writes. In particular, any read or write to the backing store 140, using a surface, is made directly against the backing store 140 (e.g., page blob) and not cached in the cache store 130. Any flush or Force Unit Access (FUA—an I/O command option that forces written data all the way to stable storage) may be ignored. Other cache types, discussed herein, perform read caching but differ in write policies. When the backing store 140 is configured with a “none” cache type, this obviates the creation or association with the cache store 130 or cache store data structures.

A cache type of “write-through” can be associated with the backing store 140 to cause a write to the backing store 140 to be forwarded directly the backing store 140 (e.g., page blob) and the data is placed in the cache store 130 and tracked in the cache store data structures. The data access request completes to the requesting device only when a confirmation is received from the backing store 140 that the data has been committed to the backing store. Any flush or Force Unit Access (FUA—an I/O command option that forces written data all the way to stable storage) may be ignored. In one example, 64 KB cache blocks are further divided into 16 Sectors, 4 KB in size. Each sector within a cache block is individually marked as not-present, present, present and dirty, as discussed in more detail herein. In order to be cached, writes that are not 4K aligned (either offset or length) are first configured to have any misaligned head or tail sectors pre-filled in the cache. By way of example, suppose a client performs an 8192 byte write that begins at offset 2048. This write spans three 4K sectors (i.e., the last 2K of sector 0, all of sector 1, and the first 2K of sector 2). Further, suppose that before the write, all of the sectors were in the “not present” state. Because all of the data within a 4K sector are advantageously required to be configured to the same state, indicating that only the last 2K of sector 0 is “present” or “dirty” becomes incongruent with the preferred configuration. To resolve this scenario, two 2K reads are sent to the backing store. One for sector 0, and one for sector 2. Sector 0 and sector 2 are now “present”. The first 2K of the write is copied into the last half of sector 0, the middle 4K is copied into sector 1, and the last 2K of the write is copied into the first half of sector 2. All three sectors are marked dirty, and are written to the backing store as a 12K write. In this regard, the pre-fill order is performed to cache the written data. It is contemplated that this behavior may or may not be preserved in varying embodiments.

A cache type of “write-back” can be associated with the backing store 140 to cause the data associated with a non-FUA write to be recorded in the cache store 130 subject to the misaligned sector prefill discussed above and respective cache blocks placed on a dirty list, to be eventually written to the backing store 140 using a lazy write operation. The command completes to the requesting device immediately. A flush and FUA on this backing store 140 are honored. A write comprising a FUA behaves as it would in write-through mode. Further, a cache type of “temporary” can be associated with the backing store 140 to cause the data to be processed ephermerally. Temporay data is copied into the cache store 130 and a complete is immediately returned to the requesting device. Flush and FUA are ignored. Unless the local cache (e.g., working set) is eventually nearly filled with dirty data, no data will be written to the backing store. Finally a cache type “persistent” can be associated with node 110 to cause data associated with data access request to stay on the node 110 even after certain failures. The data is not backed by the backing store 140; however, the data is not lost upon a power failure. In embodiments, persistent data may be accumulated and written atomically to the cache store 130 where it is retained until otherwise deleted.

With continued reference to FIG. 1, cache store 130 (or cache store component) is responsible for storing cached data. The cache store 130 generally refers to a collection of cache blocks. The cache may be local RAM (Random Access Memory) and/or (Solid-State Drive) SSD operating based on a two-tier caching scheme of a cache store data structure (e.g., working set associated with translation tables of backing stores). The cache store 130 can also be partitioned for isolated or shared caching for VMs as needed in implementations of the modular data operations system 100. The cache store 130 operates with the backing store 140. In particular, the cached data can be cached based on a corresponding backing store 140 and caching policy of the backing store 140 as described above.

The cache store 130 caches data so future requests for that data can be served faster; the data stored in a cache might be the result of an earlier computation, or the duplicate of data stored in the backing store. A cache hit occurs when the requested data can be found in a cache, while a cache miss occurs when it cannot. Cache hits are served by reading the data from the cache store component, which is faster than re-computing a result or reading from the backing store. In one embodiment, the cache store 130 is a collection of cache blocks (e.g., 64K in size). The cache store 130 may implement a memory cache store with cache blocks that reside in a non-paged pool, and a storage cache store with cache blocks that reside on local raw storage volume. In particular, a cache is implemented as a two-tier cache: tier 0 is RAM, and tier 1 is a block storage device (e.g., a local SSD). A system may have multiple cache stores, for example, a system can implement multiple SSDs that can be utilized in cache stores. An SSD may be implemented without an underlying file system, while only performing 64K reads and writes through NTFS. A RAW volume (i.e., the absence of a file system) can be created on each SSD and access to the RAW volume is executed as a simple array of 64K cache blocks.

The cache blocks with a cache store can be sub-allocated to tiers with one or more working set partitions. By way of example, four identically-sized RAM volumes [0-3] can be implemented on four SSDs and two working sets [0-1], each dedicated to all of the virtual drives associated with of the two VMs. Also, four tier-1 cache stores can be created, one on each of the RAW volumes. As such, advantageously some flexibility now exists in how the cache blocks within the stores are assigned to working sets. For example, all of the blocks in cache stores 0 and 1 can be assigned to working set 0, and all of the blocks in cache stores 2 and 3 can be assigned to working set 1. Also, half of the cache blocks from all four cache stores can be assigned to working set 0, and the other half from all four cache stores can be assigned to working set 1. Tier 0 cache store may be excluded from sub-allocation. For example, when a working set is created with 10,000 cache blocks for a tier 0 cache, 655,360,000 bytes of RAM can be allocated to be used to create a new tier 0 cache store and all of the cache blocks are assigned to the new working set. It is contemplated that cache blocks can be moved between working sets if necessary. For example, if two working sets are using all available tier 1 cache blocks and then a new working set needs to be created, ⅓ of the cache blocks can be moved from each of the two existing working sets over to the new working set.

With continued reference to FIG. 1, FIG. 1 includes a data access component 150 that supports the modular data operations system 100. The data access component 150 can be initialized on a computing device (e.g., compute node, VM, cluster) such that data operations are managed and controlled using a selective implementation of components that the data access component 150 supports. For illustrative purposes, the data access component is described with reference to node 110 running a plurality of VMs. The data access component 150 includes a working set component 152, a cache block lazy writer component 154, and data access throttling component 156.

The data access component 150 can be initialized on the node 110 to configure the modular data operations system 100. The initialization phase can include generating configuration settings, for example, identifying and selecting components, features, attributes and specifications for running the modular data operations system 100 using the data access component 150. Configuration settings can be based on the type of computing tasks to be performed on the node. For example, different customers may have different use cases that lend themselves to different configuration settings. The use cases may require implementing variations and combinations of backing store with different caching policies, cache block lazy writing, and data access throttling.

With reference to FIG. 1, the data access component 150 can be an existing part of a node operating system or the data access component 150 can be deployed onto node 110 during the initialization phase. The data access component 150 may include a default configuration for process data operations. The data access component 150 can further or additionally communicate with the administrator client 170 to receive configuration settings for the data access component 150. Configuration settings can include, selections determining whether a backing store is implemented for one or more VMs, identifying caching policies for backing stores, assigning working sets to specific backing stores, determining whether to implement a shared working set configuration or an isolated work set configuration, opting to implement the cache block lazy writer component and the data access throttling component, selection options associated with the data access throttling component, etc. Other variations and combinations of configuration settings for the modular data operations system 100 are contemplated herein.

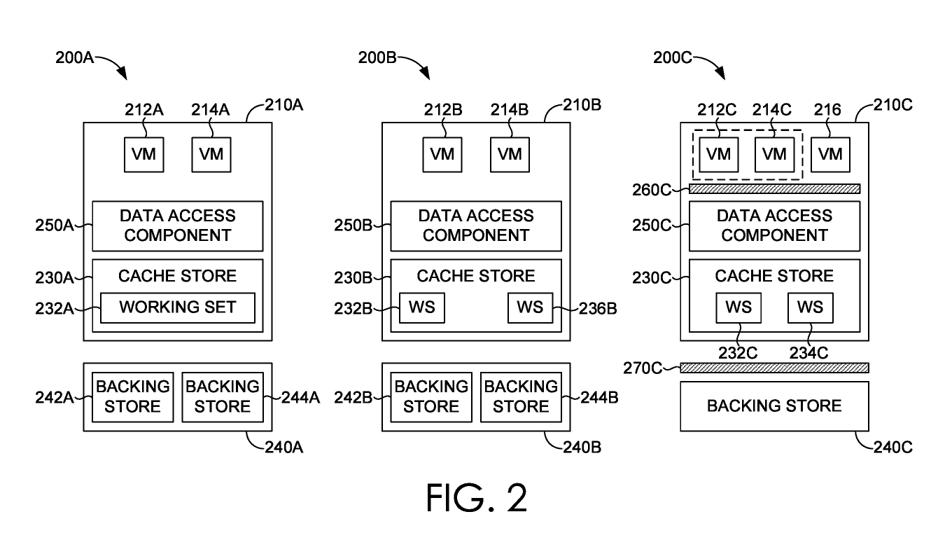

With reference to FIG. 2, various configurations of modular data operations systems are illustrated. In FIG. 2, a first system configuration 200A includes a node 210A having VM 212A and VM 214A. VM 212A and VM 214A operate with data access component 220A and a cache store 230A having a shared working set 232A between VM 212A and VM 214A. The cache store 230A is associated with a backing store 240 having two isolated backing stores—backing store 242A and backing store 244A each having a cache policy setting. Each backing store is isolated and corresponds to a VM.

A second system configuration 200B includes a node 210B having VM 212B and VM 214B. VM 212B and VM 214B operate with data access component 220B and a cache store 230B having isolated working sets WS 232B and WS 234B (partitioned in the cache store) between VM 212B and VM 214B respectively. The cache store 230B is associated with a backing store 240B having two isolated backing stores—backing store 242B and backing store 244B each having a cache policy setting. Each backing store is isolated and corresponds to a VM and/or working set in the cache store 230B.

A third system configuration 200C includes a node 210C having VM 212C, 214C and VM 216B. VM 212B, VM 214B and VM 216B operate with data access component 250C and a cache store 230C having isolated working sets (partitioned in the cache store) between VM 212C, VM 214C and VM 216C. In particular, VM 212C and VM 214C share WS 232C and VM 216C is isolated with WS 232C. The cache store 230C is associated with a backing store 240C that is shared between VM 212C, VM 214C and VM 216C. The third system configuration further includes an “above cache” throttle 260C implementation and a “below cache” throttle 270C implementation for predefined threshold conditions that throttle data access requests, in accordance with embodiment described herein. Accordingly, the configurations setting provide flexibility and granularity in supporting data operations and the settings reflects settings would appropriate support the particular use case of the customer.

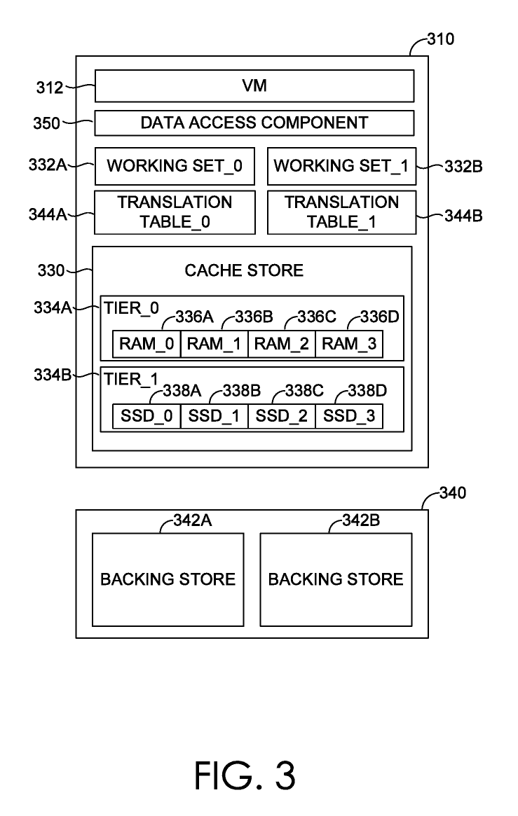

With reference to FIG. 3, a schematic of components of an exemplary modular data operations system is provided. A data access component (e.g., data access component 350) can further be responsible for providing one or more working sets (e.g., working set 332A and working set 332B) for a node (e.g., node 310). A working set primarily supports cache-related actions. A working set is a data structure that supports caching data in the modular data access system. A working set of a VM (e.g., VM 312 having a virtual drive) comprises the set of pages in a cache store (e.g., cache store 330) data space of the VM that are currently in a backing store (e.g., backing store 340 operating as backing store 342A and backing store 342B). A working set can include pageable data allocation. A working set operates with per-backing-store translation tables (e.g., translation table 344A and translation table 344B) used to translate backing-store relative file offsets to cache blocks within the working set. A working set operates with one or more tiers (e.g., tier_0 334A and tier_1 334B) of cache blocks contributed from one or more cache stores. Tier 1 can be implemented as a set of partitioned memory cache stores (e.g., RAM_0 336A, RAM_1 336B, RAM_2 336C, and RAM_3 336D) and tier 2 implemented a local SSD storage cache stores (e.g., SSD_0 338A, SSD_1 338B, SSD_2 338C, and SSD_3 3386D). At a high level, the working set includes a page table directory with pointers to page tables, the page table directory include PDEs (page table directory entries) and the page tables include PTEs (page table entries) that support the mapping of the cache store 330 to the backing store 340 for performing data operations.

Working sets also operate with backing stores. A backing store can be associated with exactly one working set, while a working set can be shared among any number of backing stores. In this regard, cached backing stores and working sets support a many-to-one relationship. Backing stores associated with a working set are eligible to use any or all of the cache blocks within the working set, as the replacement policy dictates. As discussed, a backing store can be configured with different write policies. For example, a write policy can be temporary and write-back policy. Backing stores having different policies may not reside in the same working set. By way of example, write-back and write-through backing stores may reside together in a single working set, however temporary backing stores cannot share a working set with write-back or write-through backing stores.

A working set operates based on per-backing-store translation tables and tiers. The translation table can refer to a translation or a mapping between the backing store data and the cache store data. By way of example, data may be stored based on block addresses. When a backing store is associated with a working set, a top-level page table is created and associated with the backing store. A page table is a data structure used in the data access component to store a mapping between data in the cache and data in the backing store. For example, data in the cache can be data blocks and the data in the backing store can be page blobs associated with relative file offsets in the backing store. The data blocks in the cache can be accessed by a VM accessing data via a VHD that is configured with a backing store having a blob interface to access page blobs. A VM of a plurality of VMs is given the impression that it is working with large contiguous section of data based on the cache-to-backing store configuration that can provides requested data either from the cache or the backing store. The cache store caches more recently used data blocks in a page table. When a data request is received, the cache store is searched first, by way of the working set, if a match is found, the data block is retrieved from the cache store and communicated to the requesting client. However, if there is no match, the requested data is retrieved from the backing store.

In one example, each page table consists of a single 64K cache block in tier 0 or tier 1 and each page table entry is eight bytes in size. Each page table, then, consists of 2¹³=8,192 PTEs. Two levels of page tables permit the mapping of 2²⁶ cache blocks, and with each 64K cache block contributing 2¹⁶ bytes, each cached backing store has a maximum of 2¹³⁺¹³⁺¹⁶ bytes, or 4 TB. 2¹³⁺¹⁶ bytes or 512 MB of this address space is reserved to recursively map the page tables, while the rest is available to map user data. This yields a maximum usable backing store size of 2⁴²−2²⁹, or 4 TB−512 MB, or 4,397,509,640,192 bytes.

The topmost page table is referred to as a page directory, each containing an array of 8,192 page directory entries, or PDEs. A “present” PDE references a page table, which in turn is an array of 8,192 page table entries, or PTEs. A “present” PTE references a cache line containing up to 16 sectors, each 4K in size. PDEs and PTEs share an identical format except for the Child PTE Count field, which exists only in the PDE. Page tables may exist in tier 0 or tier 1 of the cache, but as meta-data they are never written to the backing store. Client generated flushes do not impact translation tables.

Backing Store Page Table Entry

| [63:34] | [33:32] | [31:0] |
|---|---|---|
| Reserved, | Tier Level | Page Frame |
| MBZ | Plus One | Number |

Backing Store Page Directory Entry

| [63:50] | [49:36] | [35:34] | [33:32] | [31:0] |
|---|---|---|---|---|
| Reserved, | Child PTE | Reserved, | Tier Level | Page Frame |
| MBZ | Count | MBZ | Plus One | Number |

As shown, the Page Table Entry and the Page Directory Entry each include a Page Frame Number (PFN) field, a Tier Level Plus One field, a Reserved, MBZ (Must Be zero) field, the Child PTE Count field count is found only in the Page Directory Entry. The page frame number field value represents the page frame number of the target cache block within the tier.

The Tier Level Plus One field value indicates cache block tier within which the referenced page frame number resides. The Tier Level Plus One value can be selected from 0, 1 or 2. “0”—This page table entry is “not present”. A cache block for this backing store offset cannot be found within the working set. All other fields in the PTE must be zero. “1”—This page table entry is “present”. A cache block for this backing store offset can be found in tier 0, indexed at the Page Frame Number. It is possible for a cache block representing a given backing store offset to reside concurrently in both tiers 0 and 1. In this case, the tier 0 PFN is flagged as “linked” and contains a reference to the corresponding tier 1 PFN. “2”—This page table entry is “present”. A cache block for this backing store offset can be found in tier 1, indexed at the Page Frame Number. If the working set contains no tier 1 then this value is illegal.

The Child PTE Count value, used only within a PDE, contains the count of valid PTEs within the page table indexed by Page Frame Number. This value is zero if and only if the Tier Level Plus One is zero. When a PTE is marked not-present, the Child PTE Count field of the PDE corresponding to the containing page table is decremented. If the resultant value reaches zero, then the page table is freed and the PDE is marked as not-present.

Each cache block in a working set can be referenced (directly or indirectly) by a single PTE. The number of page tables required for cache translation is a function of the number and sparseness of the cache blocks. By way of example, in the worst case, up to 512 MB of translation tables may be required to represent all of the cached data for a single working set. A single working set cache tier may contain up to 232 cache blocks, or 232+16 bytes, or 256 TB of cache. In the worst case, up to 512 MB of translation tables may be required to map an entire 4 TB backing store.

With reference to tiers, one or two tiers are accessed based on a working set: tier 0 and tier 1, respectively. For example, Tier 0 may contain a minimum of 1,024 cache blocks (64 MB), though in practice a tier 0 cache may be much larger. Tier 0 can consist solely of blocks contributed from a memory cache store. Tier 1, if it exists, consists of cache blocks from one or more storage cache stores. In one exemplary embodiment, the combined blocks within tier 0 and 1 can be at least equal to the number of associated backing stores multiplied by 8,192, yielding 512 MB of cache per backing store. This minimum guarantees that all of the necessary page tables for all of the associated backing stores may reside within the cache hierarchy. As mentioned, this metadata is not migrated to the backing store in some embodiments.

The cache blocks within a specific tier may originate from different cache stores. For example: imagine three SSDs, each exposing a single cache store. All three of these cache stores may be associated with a single working set's level 1 tier. Data enters the cache at tier 0, and will migrate to tier 1 and/or the backing store as caching policy dictates. Tiers can support Cache block lists. Each tier employs 4 types of lists. Free list, present list, dirty list, and flush list. A tier can contain exactly one of the free, present and dirty lists, as well as a flush list per represented backing store. In a free list the cache blocks on this list contain no valid data, and are immediately available to be allocated and used to receive and store cached data. In the Present list, the present list can contain the cache blocks that have one or more valid sectors, and no dirty sectors. This is an ordered list, with the most recently used (MRU) block at the head and the LRU block at the tail. Whenever a cache block is accessed in order to satisfy a read, it is moved to the head of this list. When a new cache block is necessary to service a caching operation and no blocks are available in the free list, a block is removed from the LRU end of the present list, unmapped from the page translation tables, and repurposed for the new caching operation.

With reference to the dirty list, the dirty list may contain the cache blocks that contain one or more dirty sectors that are waiting to be lazily written to tier 1 or to the backing store. In the case of a two-tier working set only, the tier 0 dirty list will also contain cache blocks that contain sectors that are merely present, but do not yet exist in tier 1. Tier 0 cache blocks containing metadata (page tables) are similarly moved to tier 1 through the dirty list and lazy writer. The dirty list is ordered according to when a cache block first enters the dirty list.

Subsequent accesses (read or write) to the cache block do not perturb its order in the list. When the lazy writer initiates a write of the data within a dirty block to the next tier or to the backing store, the block is marked clean and, upon successful write completion, inserted at the head of the present list. While present data for a given backing store offset can exist concurrently in tiers 0 and 1, dirty data can exist only in one tier or the other. In the case where the same clean data resides in tier 0 and tier 1, and a write targeting a portion of this data arrives, the associated sectors are marked “dirty” in the tier 0 cache block and marked “not present” in the tier 1 cache block. The Flush list may contain the cache blocks that are being actively written (flushed) to tier 1 or to the backing store. There exists within a tier a separate flush list per backing store represented.

With reference to FIG. 1, the data access component 150 can support a cache block lazy writer component 154. The data access component 150 can employ two threads responsible for lazy writing. A single tier 0 lazy thread is responsible for servicing the tier 0 dirty and flush lists for all working sets, migrating these blocks to tier 1 or to the backing store, as appropriate. Likewise, a single tier 1 lazy thread services the tier 1 dirty and flush lists for all working sets. Absent a flush operation, a dirty block is ready to be written from the dirty list according to one of two schemes (Write-back and Temporary) depending on whether or not the working set employs a “temporary” caching policy. It is contemplated that dirty blocks employing a “temporary” caching policy may not be writing to the backing store. In some scenario, increased read and write activity (i.e., cache pressure) within the working may be associated with a threshold can trigger “temporary” dirty blocks to be written to the backing store. If sufficient cache pressure never exists to trigger writing dirty blocks to the cache store, the dirty blocks may never be written to the cache store. Further, “write-back” dirty block can be written to the backing store after being left to age on the dirty list for a defined period of time. Ideally, the “write-back” dirty blocks are alternatively merged into other dirty regions. “Write-back” dirty blocks make it to the backing store in a proactive set of operations.

In a write-back scheme, a dirty block is written when either (1) a specific time period has elapsed since the block was placed on the dirty list (e.g., 30 seconds), or (2) when the number of dirty cache blocks in the working set exceeds a given threshold (e.g., 75%). In a temporary scheme, a dirty block is written only when the number of available (non-dirty) cache blocks in the working set falls below 128, or 8 MB. Only the bottommost tier (e.g. tier 0 in a single tier working set, or tier 1 in a two-tier working set) employs this special write-back mode.

In the case of a two-tier working set only, a “present” tier 0 cache block sector is considered “dirty” if it does not exist in tier 1. In this way, the lazy writer is responsible for moving not only dirty sectors from tier 0 to tier 1 but also migrating to tier 1 any present data that does not yet reside in tier 1. In one embodiment, up to 16 asynchronous writes can be outstanding concurrently for each lazy thread. Each thread services working sets' dirty lists and backing stores' flush lists in round-robin fashion, to prevent (for example) a perpetually flushing backing store from receiving more than its share of write opportunities.

With reference to FIG. 1, the data access component 150 may further implement a data access throttling component 156 that is responsible for limiting the maximum number or rate of data operations. The data access throttling component 156 may implement throttling above the cache or below the cache, or in a shared throttle implementation or an isolated throttle implementation, as discussed above. A data access throttling component 156 can operate based on provisioned throttling. A throttle in provisioned mode is programmed with two values: Bytes Per Second (BPS) and Input/Output Per Second (IOPS). BPS represents the maximum number of bytes that will be processed per second, regardless of the number of individual transactions involved. IOPS represents the maximum number of transactions (reads or writes) that can be processed in a single second, regardless of the size of those transactions. A value of zero indicates that there is no limit. Thus, limits on IOP or bandwidth or both can be imposed. The provisioned mode can be implemented using a token-bucket scheme. By way of example, a throttle can contain two token buckets: one for BPS and one for IOPS. When an I/O is presented to the throttle, and there are sufficient tokens in the BPS bucket and at least one token in the IOPS bucket, the appropriate token quantities are deducted from the throttle token buckets and the I/O is passed on. However, if there are an insufficient number of tokens in one or both buckets, then the I/O is queued to the throttle. A periodic (e.g., 20 times/sec) throttle cycle can be implemented to replenish token buckets. When this is performed, the throttle's I/O queue is not empty, as such, pending operations of are de-queued and dispatched based on the token levels in each bucket.

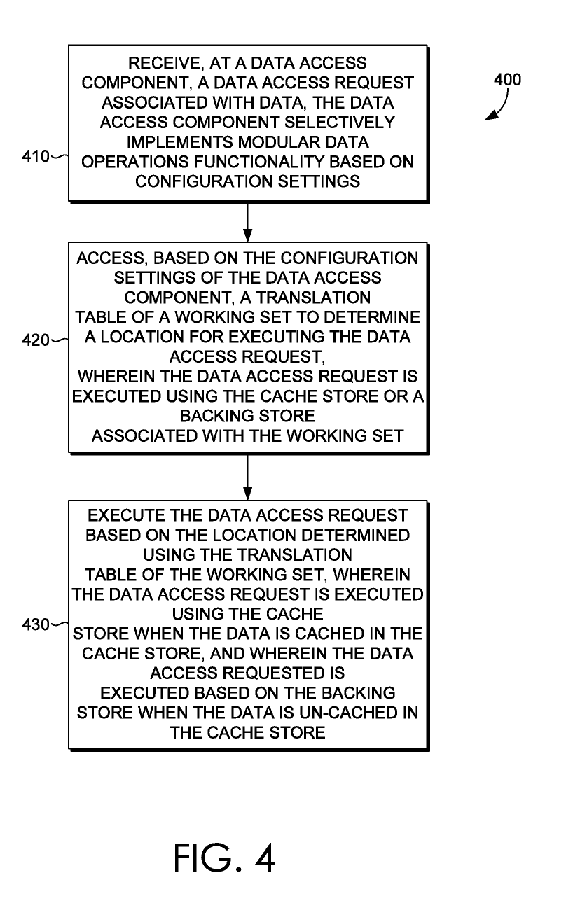

Turning now to FIG. 4, a flow diagram is provided that illustrates a method 400 for implementing modular data operations. Initially at block 410, a data access request is received at a data access component. The data access component is associated with data. The data access component selectively implements modular data operations functionality based on configuration settings. During an initialization phase, the configuration settings are configured for one or more selected modular components supported by the data access component. The configuration settings identify attributes used in processing data access requests. The data is accessible based on redirector file system. The data access request is directed to a virtual hard disk mounted as a block device operated based on a file proxy format, the data access request is converted from a file proxy format to a blob store format to access the data.

At block 420, a translation table associated with working set is accessed, based on the configuration settings of the data access component, to determine a location for executing the data access request. The translation table supports translating backing store relative file offsets to cache store blocks based on page directory entries, page table entries and page frame numbers. The data access request is executed using the cache store or a backing store associated with the working set. The cache store is registered to operate with the backing store based on a caching policy, the data access requests cause at least a subset of the data in the backing store to be cached in the cache store based on the caching policy. The data access request is processed based on the caching policy of the backing store, the caching policy is selected from one of the following: none, write-through, write-back, temporary, and persistent, as discussed hereinabove.

At block 430, the data access request is executed based on the location determined using the translation table of the working set. The data access request is executed using the cache store when the data is cached in the cache store, and the data access requested is executed based on the backing store when the data is un-cached in the cache store. In various embodiments, execution of the data access request is throttled based on a predefined threshold.

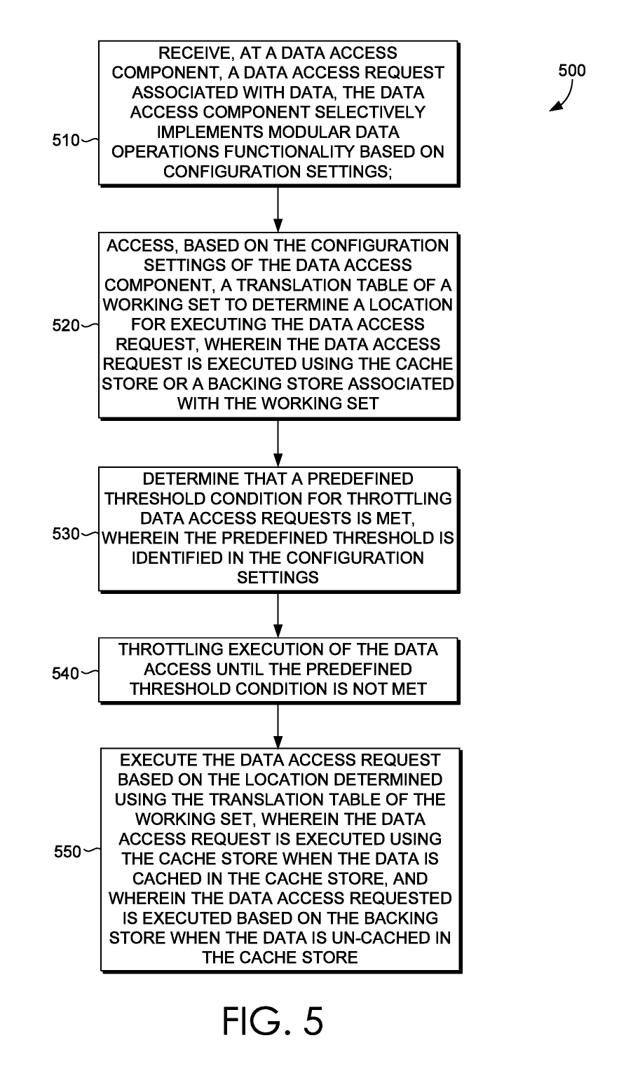

Turning now to FIG. 5, a flow diagram is provided that illustrates a method 500 for implementing modular data operations. Initially at block 510, a data access request is received at a data access component. The data access component is associated with data. The data access component selectively implements modular data operations functionality based on configuration settings. At block 520, a translation table associated with working set is accessed, based on the configuration settings of the data access component, to determine a location for executing the data access request. The translation table supports translating backing store relative file offsets to cache store blocks based on page directory entries, page table entries and page frame numbers. The data access request is executed using the cache store or a backing store associated with the working set.

At block 530, a determination that a predefined threshold condition for throttling data access requests is met, the predefined threshold is identified in the configuration settings. The predefined threshold condition for throttling data access is defined for a cache store data access request or a backing store data access request. The predefined threshold condition for throttling data access is defined for Bytes Per Second (BPS) or Input/Output Operations Per Second (IOPS). At block 540, the execution of the data access is throttled until the predefined threshold condition is not met.

At block 550, the data access request is executed based on the location determined using the translation table of the working set. The data access request is executed using the cache store when the data is cached in the cache store, and the data access requested is executed based on the backing store when the data is un-cached in the cache store. In various embodiments, execution of the data access request is throttled based on a predefined threshold.

With reference to the modular data operations system, embodiments described herein can improve data access performance based on a modular data operations service platform. Modular data operations service platform components refer to integrated components for managing access to data. The integrated components refer to the hardware architecture and software framework that support data access functionality using the modular data operations service platform. The hardware architecture refers to physical components and interrelationships thereof and the software framework refers to software providing functionality that can be implemented with hardware operated on a device. The end-to-end software-based modular data operations service platform can operate within the modular data operations service platform components to operate computer hardware to provide modular data operations service platform functionality. As such, the modular data operations service platform components can manage resources and provide services for the modular data operations service functionality. Any other variations and combinations thereof are contemplated with embodiments of the present invention.

By way of example, the modular data operations service platform can include an API library that includes specifications for routines, data structures, object classes, and variables may support the interaction the hardware architecture of the device and the software framework of the modular data operations service platform system. These APIs include configuration specifications for the modular data operations service platform system such that the data access component and component therein can communicate with each other in the modular data operations service platform, as described herein.

Having briefly described an overview of embodiments of the present invention, an exemplary operating environment in which embodiments of the present invention may be implemented is described below in order to provide a general context for various aspects of the present invention. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output ports 618, input/output components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc.

Referring now to FIG. 7, FIG. 7 illustrates an exemplary distributed computing environment 700 in which implementations of the present disclosure may be employed. In particular, FIG. 7 shows a high level architecture of the modular data operations platform system (“system”) comprising a cloud computing platform 710, where the system supports implementing modular data operations. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Data centers can support the distributed computing environment 700 that includes the cloud computing platform 710, rack 720, and node 730 (e.g., computing devices, processing units, or blades) in rack 720. The system can be implemented with a cloud computing platform 710 that runs cloud services across different data centers and geographic regions. The cloud computing platform 710 can implement a fabric controller 740 component for provisioning and managing resource allocation, deployment, upgrade, and management of cloud services. Typically, the cloud computing platform 710 acts to store data or run service applications in a distributed manner. The cloud computing infrastructure 710 in a data center can be configured to host and support operation of endpoints of a particular service application. The cloud computing infrastructure 710 may be a public cloud, a private cloud, or a dedicated cloud.

The node 730 can be provisioned with a host 750 (e.g., operating system or runtime environment) running a defined software stack on the node 130. Node 730 can also be configured to perform specialized functionality (e.g., compute nodes or storage nodes) within the cloud computing platform 710. The node 730 is allocated to run one or more portions of a service application of a tenant. A tenant can refer to a customer utilizing resources of the cloud computing platform 710. Service application components of the cloud computing platform 710 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by the nodes 730, the nodes may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in the cloud computing platform 710. It is contemplated that resources can be configured for specific service applications. Further, each service application may be divided into functional portions such that each functional portion is able to run on a separate virtual machine. In the cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 180 may be linked to a service application in the cloud computing platform 710. The client device 780 may be any type of computing device, which may correspond to computing device 600 described with reference to FIG. 6, for example. The client device 780 can be configured to issue commands to cloud computing platform 710. In embodiments, client device 780 may communicate with service applications through a virtual Internet Protocol (IP) and load balancer or other means that directs communication requests to designated endpoints in the cloud computing platform 710. The components of cloud computing platform 710 may communicate with each other over a network (not shown), which may include, without limitation, one or more local area networks (LANs) and/or wide area networks (WANs).

Having described various aspects of the distributed computing environment 700 and cloud computing platform 710, it is noted that any number of components may be employed to achieve the desired functionality within the scope of the present disclosure. Although the various components of FIG. 7 are shown with lines for the sake of clarity, in reality, delineating various components is not so clear, and metaphorically, the lines may more accurately be grey or fuzzy. Further, although some components of FIG. 7 are depicted as single components, the depictions are exemplary in nature and in number and are not to be construed as limiting for all implementations of the present disclosure.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

[Pending Final Claim Set for Literal Support for PCT Claims]

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a head-mounted display unit; however the head-mounted display unit depicted herein is merely exemplary. Components can be configured for performing novel aspects of embodiments, where configured for comprises programmed to perform particular tasks or implement particular abstract data types using code. Further, while embodiments of the present invention may generally refer to the head-mounted display unit and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A system for implementing modular data operations, the system comprising:
a backing store configured to:
store data associated with data access requests, wherein data in the backing store is cached in one or more cache stores;
a cache store configured to:
cache data associated with the data access requests, wherein the cache store is configured to operate with the backing store, the cache store caches at least a subset of the data in the backing store;
a data access component configured to:
receive a data access request associated with data, the data access component selectively implements modular data operations functionality based on configuration settings;
access, based on the configuration settings of the data access component, a translation table associated with a working set to determine a location for executing the data access request, wherein the data access request is executed using the cache store or a backing store associated with the working set; and
execute the data access request based on the location determined using the translation table of the working set, wherein the data access request is executed using the cache store when the data is cached in the cache store, and wherein the data access requested is executed based on the backing store when the data is un-cached in the cache store.

2. The system of claim 1, further comprising a redirector component that supports a redirector file system, wherein the data access request is directed to a virtual hard disk mounted as a block device operated based on a file proxy format, the data access request is converted from a file proxy format to a blob store format to access the data in the cache store or the backing store.

3. The system of claim 1, further comprising a data access throttling component configured to throttle data access requests based on a predefined threshold, wherein data access throttle is implemented for data access requests to at least one of the following: the cache store or the backing store.

4. The system of claim 1, wherein the translation table supports translating backing store relative file offsets to cache store blocks based on page directory entries, page table entries and page frame numbers.

5. The system of claim 1, further comprising a node configured to run a virtual machine, wherein the node initializes the data access component on the node, wherein initializing the data access component comprises receiving one or more selected modular data operations components and corresponding configuration settings for processing data access requests.

6. The system of claim 1, further comprising a cache block lazy writer component configured to lazily write cache blocks to the backing store, wherein the cache block lazy writer component writes dirty cache blocks to the backing store based on a write-back scheme or a temporary scheme.

7. A computer-implemented method for implementing modular data operations, the method comprising:
receiving, at a data access component, a data access request associated with data, the data access component selectively implements modular data operations functionality based on configuration settings;
accessing, based on the configuration settings of the data access component, a translation table associated with a working set to determine a location for executing the data access request, wherein the data access request is executed using the cache store or a backing store associated with the working set; and
executing the data access request based on the location determined using the translation table of the working set, wherein the data access request is executed using the cache store when the data is cached in the cache store, and wherein the data access requested is executed based on the backing store when the data is un-cached in the cache store.

8. The method of claim 7, wherein, during an initialization phase, the configuration settings are configured for one or more selected modular components supported by the data access component, wherein the configuration settings identify attributes used in processing data access requests.

9. The method of claim 7, wherein the data is accessible based on a redirector file system, wherein the data access request is directed to a virtual hard disk mounted as a block device operated based on a file proxy format, the data access request is converted from a file proxy format to a blob store format to access the data

10. The method of claim 7, wherein the cache store is registered to operate with the backing store based on a caching policy, wherein data access requests cause at least a subset of the data in the backing store to be cached in the cache store based on the caching policy.

11. The method of claim 10, wherein the data access request is processed based on the caching policy of the backing store, wherein the caching policy is selected from one of the following: none, write-through, write-back, temporary, and persistent.

12. The method of claim 7, wherein the translation table supports translating backing store relative file offsets to cache store blocks based on page directory entries, page table entries and page frame numbers.

13. The method of claim 7, further comprising throttling execution of the data access request based on a predefined threshold.

14. One or more computer storage media having computer-executable instructions embodied thereon that, when executed, by one or more processors, causes the one or more processors to perform a method for implementing modular data operation system, the method comprising:
receiving, at a data access component, a data access request associated with data, the data access component selectively implements modular data operations functionality based on configuration settings;
accessing, based on the configuration settings of the data access component, a translation table associated with a working set to determine a location for executing the data access request, wherein the data access request is executed using the cache store or a backing store associated with the working set;
determining that a predefined threshold condition for throttling data access requests is met, wherein the predefined threshold is identified in the configuration settings;
throttling execution of the data access until the predefined threshold condition is not met; and
executing the data access request based on the location determined using the translation table of the working set, wherein the data access request is executed using the cache store when the data is cached in the cache store, and wherein the data access requested is executed based on the backing store when the data is un-cached in the cache store.

15. The media of claim 14, wherein the predefined threshold condition for throttling data access is defined for a cache store data access request or a backing store data access request.

16. The media of claim 14, wherein the predefined threshold condition for throttling data access is defined for Bytes Per Second (BPS) or Input/Output Operations Per Second (IOPS).

17. The media of claim 14, wherein the BPS and IOPS are implemented based on a two-bucket token scheme that processes the data request based on availability of corresponding sufficient tokens for both the BPS and IOPS for the data request.

18. The media of claim 14, wherein the data access request is processed based on the caching policy of the backing store, wherein the caching policy is selected from one of the following: none, write-through, write-back, temporary, and persistent.

19. The media of claim 14, wherein the translation table supports translating backing store relative file offsets to cache store blocks based on page directory entries, page table entries and page frame numbers.

20. The media of claim 14, wherein the working set includes one or more tiers of cache blocks, a tier maintains four lists of cache blocks, the lists comprising a free list, a present list, a dirty list, and a flush list.
